(19) United States
(12) Patent Application Publication
(10) Pub. No.: US 2025/0162404 A1
(43) Pub. Date: May 22, 2025

(54) VEHICLE LID DEVICE

(71) Applicant: TOYOTA JIDOSHA KABUSHIKI KAISHA, Toyota-shi (JP)

(72) Inventor: Shiroh CHIBA, Nisshin-shi (JP)

(73) Assignee: TOYOTA JIDOSHA KABUSHIKI KAISHA, Toyota-shi (JP)

(21) Appl. No.: 18/780,919

(22) Filed: Jul. 23, 2024

(30) Foreign Application Priority Data
Nov. 16, 2023 (JP) 2023-194865

(51) Int. Cl. B60K 15/05

(52) U.S. Cl. CPC B60K 15/05

(57) ABSTRACT

A vehicle lid device, comprising: a lid arm rotatably mounted on a body of the vehicle and configured to open and close an opening for refueling provided on the body; and an outer panel mounted on an outer side of the lid arm and having a surface constituting a design surface of the body, wherein the lid arm includes at least one protrusion protruding toward the outer panel and having a tip end in contact with a rear surface of the outer panel.

### CROSS-REFERENCE TO RELATED APPLICATION

This application claims priority to Japanese Patent Application No. 2023-194865 filed on Nov. 16, 2023, incorporated herein by reference in its entirety.

### BACKGROUND

### 1. Technical Field

The present disclosure relates to the structure of a vehicle lid device.

### 2. Description of Related Art

Japanese Unexamined Patent Application Publication No. 2022-108086 (JP 2022-108086 A) discloses a lid device including a housing, a lid arm rotatably attached to the housing, and an outer panel attached to the lid arm. The lid arm of the lid device is provided with reinforcing ribs that extend toward the outer panel.

### SUMMARY

In some cases, an outer panel of a vehicle lid device is made of a resin such as polyphenylether (PPE) and polyamide (PA). Since these resins have water absorption, the outer panel swells due to water absorption in rainy weather. At this time, if the outer panel has a surface having a large amount of water absorption and a surface having a small amount of water absorption, the outer panel may swell by a large amount on the surface having a large amount of water absorption, and may warp such that the surface having a large amount of water absorption swells. When the outer panel of the vehicle lid device warps, an end portion of the outer panel may float from the body to deteriorate the appearance.

Thus, an object of the present disclosure is to suppress the warpage of a resin outer panel of a vehicle lid.

An aspect of the present disclosure provides a vehicle lid device including: a lid arm rotatably attached to a body of a vehicle to open and close a fuel supply opening or a power supply opening provided in the body; and
an outer panel attached to an outer side of the lid arm so that a surface of the outer panel constitutes a design surface of the body, in which
the lid arm includes one or more protrusions that protrude toward the outer panel so that a distal end of the protrusions contacts a back surface of the outer panel.

By causing the distal end of the protrusions to contact the back surface of the outer panel in this manner, it is possible to suppress the warpage caused when the resin outer panel swells due to water absorption. In addition, this can suppress floating of an end portion of the outer panel, suppressing the deterioration of the appearance.

In the vehicle lid device according to the aspect,
at least one of the protrusions may be provided at a central portion of a panel portion of the lid arm to which the outer panel is attached;
a plurality of fixing portions to which the outer panel is fixed may be provided at an outer peripheral portion of the panel portion of the lid arm; and
the fixing portions may be disposed at an outer peripheral portion so as to interpose at least one of the protrusions.

Since the fixing portions for the outer panel are provided at the outer peripheral portion of the lid arm so as to interpose the protrusions in this manner, it is possible to suppress the resin outer panel warping so as to be recessed toward the lid arm due to water absorption.

In the vehicle lid device according to the aspect,
the lid arm may include a plurality of reinforcing ribs provided on an outer surface of the panel portion to extend in an up-down direction of the vehicle when attached to the body;
the reinforcing ribs may be arranged side by side in a lateral direction with a gap between the reinforcing ribs; and
the protrusions may protrude from a distal end of the reinforcing ribs toward the outer panel.

Accordingly, the gap between the reinforcing ribs can be used as a drain path from the space between the lid arm and the outer panel, and it is possible to suppress water accumulating in the space between the lid arm and the outer panel.

The present disclosure can suppress the warpage of a resin outer panel of a vehicle lid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a lid device according to an embodiment, in which an outer panel is removed;

FIG. 2 is a cross-sectional view of the lid device of the embodiment, which is a II-II cross-section shown in FIG. 1;

FIG. 3 is a cross-sectional view of a contrasting lid device; and

FIG. 4 is a plan view illustrating another shape of the reinforcing rib and the protrusion.

### DETAILED DESCRIPTION OF EMBODIMENTS

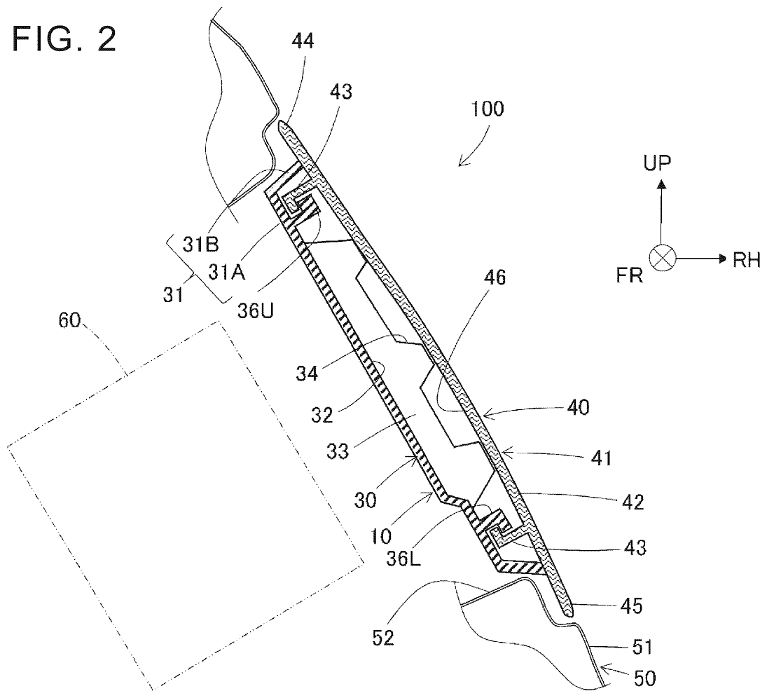

Next, a vehicle lid device (hereinafter referred to as a lid device 100) according to an embodiment will be described with reference to the drawings. Note that FR, UP, RH illustrated in the drawings respectively indicate the front side, the upper side, and the right side of the vehicles to which the lid device 100 is attached. In addition, the opposite directions of FR, UP, RH indicate the rear side, the lower side, and the left side. In the following description, the front side, the upper side, and the right side of the vehicle in a state in which the lid device 100 attached to the vehicle closes the oil supply opening 52 (see FIG. 2) provided on the side surface of the body 50 will be described as the front side, the upper side, and the right side of the lid device 100, respectively.

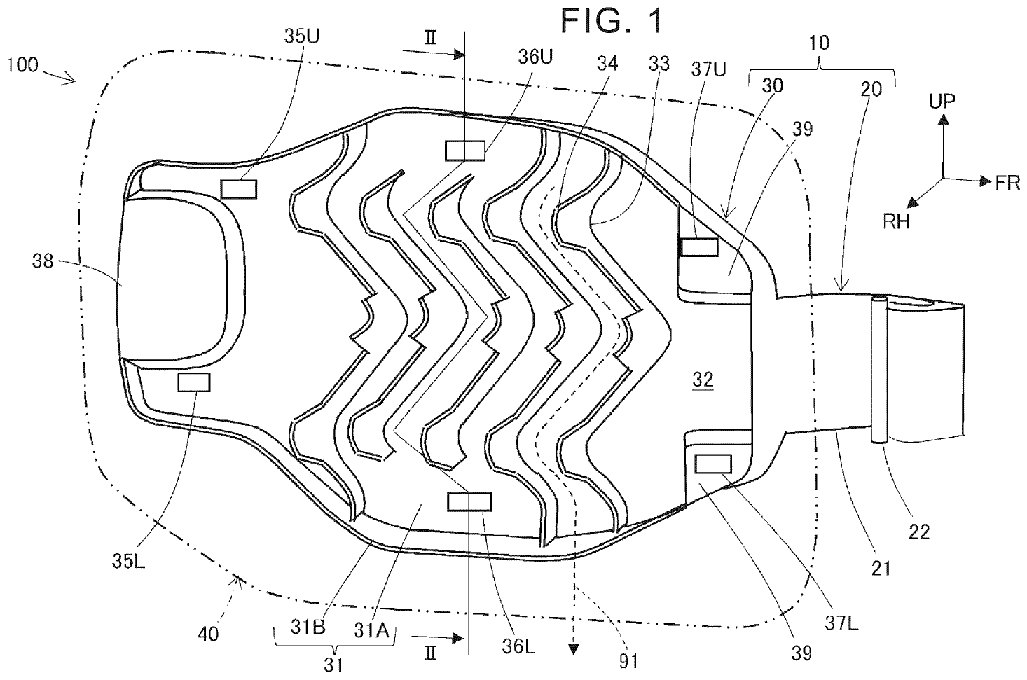

As illustrated in FIGS. 1 and 2, the lid device 100 is a device that opens and closes the oil supply opening 52 provided in the body 50 of the vehicle. An oil supply port 60 is provided in the oil supply opening 52. The lid device 100 includes a lid arm 10 and an outer panel 40. The lid arm 10 is a member that is rotatably attached to the body 50 of the vehicle and opens and closes the oil supply opening 52 provided on the side surface of the body 50. The outer panel 40 is attached to the outside of the lid arm 10, and the surface 42 is a resin plate member constituting the design surface of the body 50.

The lid arm 10 includes an attachment portion 20 and a panel portion 30. The attachment portion 20 includes a pipe 22 that is rotatably attached to the body 50, and an arm 21 that is bent from the pipe 22 and extends toward the outside of the body 50. The panel portion 30 is a plate-shaped portion connected to the distal end of the arm 21. An outer panel 40 is attached to the outer surface 32 of the panel portion 30. The panel portion 30 includes a base panel 31, a plurality of reinforcing ribs 33, a plurality of protrusions 34, and a plurality of engaging claws 35U, 35L, 36U, 36L, 37U, 37L. The plurality of engaging claws 35U, 35L, 36U, 36L, 37U, 37L constitute a fixing portion.

The base-panel 31 is a thin tray-type member including a substantially octagonal plate portion 31A and a flange 31B rising to an outer peripheral end of the plate portion 31A. The reinforcing ribs 33 are plate members that extend in a zigzag manner in the vertical direction and are provided on the outer surface 32 of the plate portion 31A on the outer side in the vehicle-width direction. A plurality of reinforcing ribs 33 are arranged side by side at intervals in the lateral direction. The lateral direction is the vehicle front-rear direction. The protrusion 34 is provided at each bent portion of each reinforcing rib 33. Each protrusion 34 protrudes from the distal end of the reinforcing rib 33 toward the outer panel 40, and the distal end of each protrusion 34 is in contact with the rear surface 46. The three engaging claws 35U, 36U, 37U are arranged side by side in the upper outer peripheral portion of the plate portion 31A from the rear of the vehicle toward the front of the vehicle. The three engagement claws 35L, 36L, 37L are arranged side by side in the lower outer peripheral portion of the plate portion 31A from the rear of the vehicle toward the front of the vehicle. Further, a base portion 38 raised from the plate portion 31A is provided at a rear end portion of the base panel 31. In addition, a base portion 39 raised from the plate portion 31A is provided at a front portion of the base panel 31.

The plurality of engaging claws 35U, 35L, 36U, 36L, 37U, 37L are provided at three positions in the upper outer peripheral portion and the lower outer peripheral portion of the plate portion 31A in a row in the vehicle front-rear direction. Therefore, the plurality of protrusions 34 are arranged in the center portion of the plate portion 31A so as to be surrounded by the plurality of engaging claws 35U, 35L, 36U, 36L, 37U, 37L. Therefore, the protrusions 34 are sandwiched in the up-down direction, the front-rear direction, or the oblique direction by any two of the plurality of engaging claws 35U, 35L, 36U, 36L, 37U, 37L. For example, as shown in FIG. 2, the three protrusions 34 arranged in the vertical center are sandwiched between the engaging claw 36U and the engaging claw 36L arranged in the upper and lower outer peripheral portions. As described above, the plurality of engaging claws 35U, 35L, 36U, 36L, 37U, 37L are arranged so as to sandwich the at least one protrusion 34 from the up-down direction, the front-rear direction, or the oblique direction.

The outer panel 40 includes a panel main body 41 and a plurality of engaging claws 43. As shown in FIG. 1, the panel main body 41 is a rectangular resin plate member, and the surface 42 constitutes a design surface of the body 50. The engaging claw 43 is erected on the rear surface 46 of the panel main body 41. The engaging claws 43 are provided at positions corresponding to the plurality of engaging claws 35U, 35L, 36U, 36L, 37U, 37L provided on the base-panel 31, and their respective ends engage with the plurality of engaging claws 35U, 35L, 36U, 36L, 37U, 37L. As shown in FIG. 2, when the engaging claws 43 are engaged with the plurality of engaging claws 35U, 35L, 36U, 36L, 37U, 37L, the outer peripheral portion of the panel main body 41 comes into contact with the distal end of the flange 31B of the base panel 31 and the distal end of the plurality of protrusions 34. In addition, the upper end 44 of the panel main body 41 and the surface 42 of the lower end 45 are substantially flush with the design surface of the side panel 51 of the body 50.

A coating material is applied to the front surface 42 and the rear surface 46 of the panel main body 41. The thickness of the coating film on the front surface 42 is larger than the thickness of the coating film on the rear surface 46.

Next, a case where water is splashed on the lid device 100 will be described. When water is applied to the lid device 100, the water is applied to the front surface 42 and the rear surface 46 of the outer panel 40. Since the outer panel 40 is made of resin, the outer panel 40 absorbs water applied to the surface 42 and swells. As described above, since the coating film thickness of the front surface 42 is larger than the coating film thickness of the rear surface 46, the rear surface 46 is more likely to cause water to get into the inside than the front surface 42. Therefore, the amount of water absorbed by the panel main body 41 from the rear surface 46 is larger than the amount of water absorbed by the panel main body 41 from the front surface 42, and the amount of swelling in the vicinity of the rear surface 46 is larger than the amount of swelling in the vicinity of the front surface 42. Then, the panel main body 41 is bent back so as to be recessed toward the plate portion 31A of the base panel 31, the upper end 44 and the lower end 45 is to float from the design surface of the side panel 51. However, since the protrusion 34 is disposed on the plate portion 31A so as to be in contact with the rear surface 46 of the outer panel 40, the warpage of the panel main body 41 is restrained. As described above, the lid device 100 of the embodiment can suppress the warpage of the outer panel 40 when water is applied.

Further, the water entering between the outer panel 40 and the base panel 31, as shown by the broken line 91 in FIG. 1, flows downward through the gap between the plurality of reinforcing ribs 33, is drained from the lower portion of the base panel 31.

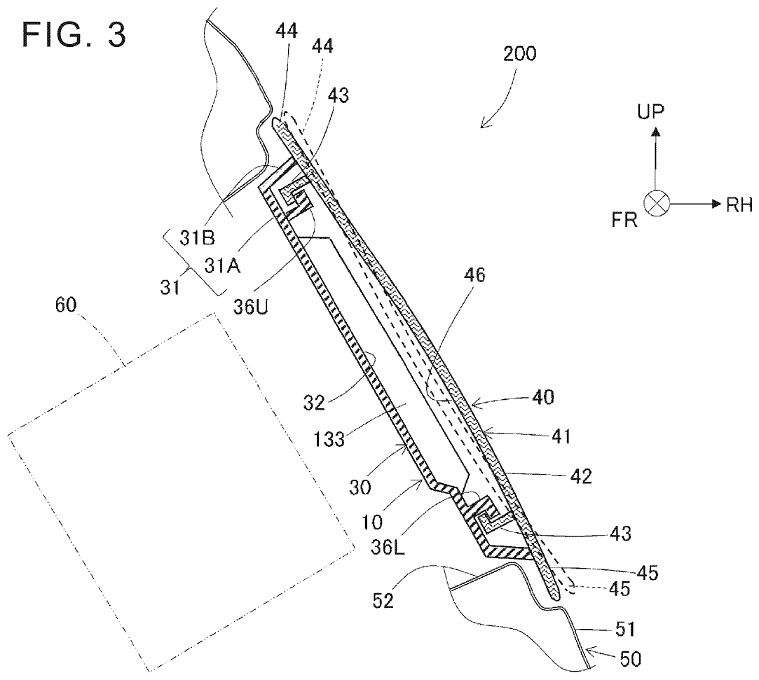

Next, a case where storm water is applied to the lid device 110 in a proportional manner will be described with reference to FIG. 3. The proportional lid device 110 has the same configuration as the lid device 100 described above except that the reinforcing rib 133 that does not include the protrusion 34 instead of the reinforcing rib 33 is erected on the plate portion 31A of the base panel 31.

When water is applied to the lid device 110 of the comparative example shown in FIG. 3, since there is no protrusion 34, as shown by a broken line in FIG. 3, the panel main body 41 is warped and deformed so as to be recessed toward the plate portion 31A of the base panel 31. Therefore, the upper end 44 and the lower end 45 of the panel main body 41 float, so that a step is formed between the design surface of the side panel 51 of the body 50.

On the other hand, in the lid device 100 according to the embodiment, as described above, when water is applied, the protrusion 34 restrains the warpage of the panel main body 41, thereby suppressing the warpage deformation of the outer panel 40.

As described above, in the lid device 100, a plurality of engaging claws 35U, 35L, 36U, 36L, 37U, 37L for fixing the outer panel 40 to the outer peripheral portion of the base panel 31 are provided so as to sandwich the protrusion 34. The protrusion 34 is in contact with the rear surface 46 of the outer panel 40. As a result, it is possible to prevent the resin outer panel 40 swelled by the water absorption from warping and deforming so as to be recessed toward the base panel 31. Further, it is possible to prevent the upper end 44 and the lower end 45 from floating due to the warpage, and to prevent a decrease in appearance.

Further, in the lid device 100, the gap between the plurality of reinforcing ribs 33 constitutes a drain path from the space between the base panel 31 and the outer panel 40. Accordingly, it is possible to prevent water from accumulating in the space between the base panel 31 and the outer panel 40.

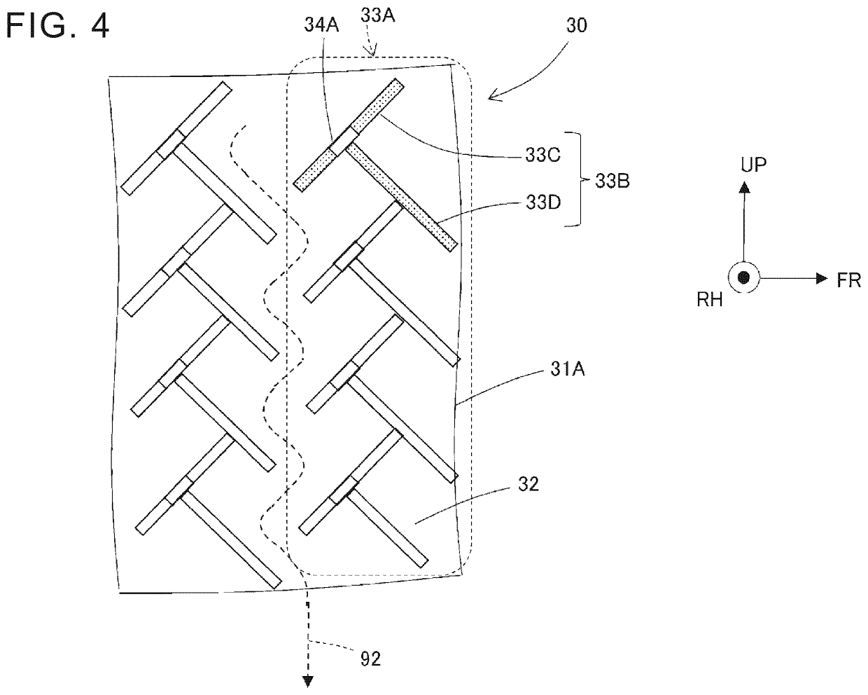

Next, referring to FIG. 4, a reinforcing rib 33A of another shape and a protrusion 34A of another shape will be described. Other shapes of the reinforcing rib 33A are erected on the outer surface 32 of the plate portion 31A of the base panel 31 in the same manner as the reinforcing rib 33 described above with reference to FIGS. 1 and 2. As shown in FIG. 4, the reinforcing rib 33A includes a plurality of rib units 33B. The rib units 33B are formed by combining a strip-shaped flat plate 33C, 33D into a T-shape. In FIG. 4, one rib unit 33B is shown in shaded form. The reinforcing rib 33A is obtained by vertically connecting the rib unit 33B so that the direction of the flat plate 33C, 33D of the T-shaped rib unit 33B is an oblique direction. The connecting portion between the flat plate 33C and the flat plate 33D is provided with a protrusion 34A protruding from the front end of the flat plate 33C toward the outer panel 40. The front end of the protrusion 34A is in contact with the rear surface 46 of the outer panel 40.

As shown in FIG. 4, in the plate portion 31A, a plurality of reinforcing ribs 33A are arranged laterally with a gap therebetween. As indicated by the broken line 92 in FIG. 4, the gap between the plurality of reinforcing rib 33A constitutes a drain path from the space between the base panel 31 and the outer panel 40.

The lid device 100 including the reinforcing rib 33A and the protrusion 34A of the other shapes shown in FIG. 4 in place of the reinforcing rib 33 and the protrusion 34 described above can suppress the warpage deformation of the outer panel 40 when the outer panel is watered as described above. In addition, it is possible to prevent water from accumulating in the space between the base panel 31 and the outer panel 40.

Although the above-described lid device 100 has been described as opening and closing the oil supply opening 52 provided on the side surface of the body 50, the present disclosure is not limited thereto, and may be configured to open and close a power supply opening (not shown) provided on the side surface of the body 50. Further, the lid device 100 may be configured to open and close a power supply opening provided on the front surface or the rear surface of the body 50. When the lid device 100 is provided on the front surface or the rear surface of the body 50, the lateral direction of the lid device 100 is the vehicle width direction.

Further, in the above description, the protrusion 34 has been described as being provided at the distal end of the reinforcing rib 33 is not limited thereto, it may be provided on the outer surface 32 of the plate portion 31A independently of the reinforcing rib 33.

What is claimed is:

1. A vehicle lid device comprising:
a lid arm rotatably attached to a body of a vehicle to open and close a fuel supply opening or a power supply opening provided in the body; and
an outer panel attached to an outer side of the lid arm so that a surface of the outer panel constitutes a design surface of the body, wherein the lid arm includes one or more protrusions that protrude toward the outer panel so that a distal end of the protrusions contacts a back surface of the outer panel.

2. The vehicle lid device according to claim 1, wherein:
at least one of the protrusions is provided at a central portion of a panel portion of the lid arm to which the outer panel is attached;
a plurality of fixing portions to which the outer panel is fixed is provided at an outer peripheral portion of the panel portion of the lid arm; and
the fixing portions are disposed at an outer peripheral portion so as to interpose at least one of the protrusions.

3. The vehicle lid device according to claim 2, wherein:
the lid arm includes a plurality of reinforcing ribs provided on an outer surface of the panel portion to extend in an up-down direction of the vehicle when attached to the body;
the reinforcing ribs are arranged side by side in a lateral direction with a gap between the reinforcing ribs; and
the protrusions protrude from a distal end of the reinforcing ribs toward the outer panel.
